(19) United States
(12) Patent Application Publication
(10) Pub. No.: US 2010/0145770 A1
(43) Pub. Date: Jun. 10, 2010

(54) Methods and Systems of Performing Marketing and Market Research

(76) Inventors: Jennifer Elizabeth Hanson, Norwalk, CT (US); Douglas Frank Haley, Ridgefield, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/519,478

(22) PCT Filed: Dec. 17, 2007
(86) PCT No.: PCT/US2007/087714

§ 371 Date: Jan. 20, 2010

Related U.S. Application Data
(60) Provisional application No. 60/870,591, filed on Dec. 18, 2006.

(51) Int. Cl. G06Q 10/00; G06Q 30/00; G06F 17/30

(52) U.S. Cl. 705/10; 707/776; 707/E17.014

(57) ABSTRACT

Some embodiments of the disclosed subject matter include a method of performing marketing and market research. In some embodiments, the method includes the following: observing a consumer using at least one of a product and a service, thereby creating data; analyzing behaviors of the consumer using the product or service by reviewing and coding the data, according to a predefined dictionary of terms thereby generating research data; interviewing the consumer thereby generating additional research data; entering the research data and the additional research data into a database; mining and analyzing the database to link the behaviors of the consumer with potential business implications, thereby generating findings; and reporting findings.

### BACKGROUND

(1) Field

The disclosed subject matter generally relates to marketing and market research. In particular, the disclosed subject matter is directed to systems and methods of performing marketing and market research related to products and services used by businesses and individuals.

(2) Description of the Related Art

Marketers collect consumer and customer behaviors and thoughts through traditional qualitative (i.e., focus groups or ethnographies) and surveys. This information, or intelligence, is gathered through an interview, whether in-person or online. The interview, or self-reported, method of data collection has been shown to only capture roughly 10% of actual behaviors and thoughts. This marketing information or data currently collected from consumers and customers is missing what people do not recognize and the motives behind their behavior. Academic research has demonstrated up to 90% of actual behaviors and thoughts are sub- or unconscious and therefore cannot be collected with existing market research methods. This fact makes interview based techniques sub-par in understanding and predicting consumer behaviors and choices. Decisions are being made with this incomplete data, which increases the risk in the decision-making process for businesses. In order to provide more complete and accurate marketing intelligence, data must include actual behaviors and thoughts, which requires collection of unconscious motives and decisions. This data can only be captured by collecting non-interview based information through videos, written or oral diaries, and other means of anthropological, sociological, and psychological study.

The current data is structured and standardized by the market research industry to allow existing statistical tools to be applied in order to deliver answers to marketing for business decisions. This means everything today is measured on the same standardized scale, such as “yes”/“no” or “1” to “5” rating scales. The tools used today cannot analyze non-interview based or “free-form” data. Understanding and predicting actual behavior and thoughts requires collecting large scale data through non-interview based data collection methods and statistically analyzing this information using tools that can handle un-standardized and unstructured information. The existing statistical tools cannot accommodate different types of “free-form” information (i.e., videos and diaries) to allow quantitative measurements that are more complete and actionable than existing metrics.

The limited scope of the data collected and the mass standardization for statistical analysis has inadvertently resulted in common marketing intelligence information across companies, rather than helping marketers create competitive advantages. The result is a reliance on marketing intelligence that has a negative impact on businesses, not a positive impact. Marketers continue to use these techniques, as there are no other ways to collect the information necessary to provide senior management with the quantitative measurements or metrics they need to feel confident in their business decisions.

Marketing intelligence information is typically reported in charts and numbers, which makes it difficult to demonstrate marketing results to senior management or business decision makers. Including real, or actual, examples of behaviors and thoughts in a multi-media format creates a powerful communication tool for marketers and management to understand marketing intelligence findings that improve business decisions.

Although growing, the market research industry is in trouble. Mainstream techniques, widespread standardization, and limited value-added research and development has resulted in a lack of ownable business knowledge leading to marketing challenges that cannot be corrected with existing methods including increased new product failures, rise of private label (lack of ownable brand equity), among others.

### BRIEF SUMMARY

Some embodiments of the disclosed subject matter include a method of performing marketing and market research. In some embodiments, the method includes the following: observing a consumer using at least one of a product and a service, thereby creating data; analyzing behaviors of the consumer using the product or service by reviewing and coding the data, according to a predefined dictionary of terms thereby generating research data; interviewing the consumer thereby generating additional research data; entering the research data and the additional research data into a database; mining and analyzing the database to link the behaviors of the consumer with potential business implications, thereby generating findings; and reporting findings.

Some embodiments of the disclosed subject matter include a method of performing market research. In some embodiments, the method includes the following: filming the consumer using at least one of a product and a service thereby creating a documentary film; analyzing behaviors of the consumer using the product or service by reviewing the documentary film; coding the documentary film according to a predefined dictionary of terms thereby generating research data; interviewing the consumer regarding the behaviors using the product or service thereby generating additional research data; entering the research data and the additional research data into a database; mining and analyzing the database to link the behaviors of the consumer with potential business implications thereby generating findings; and reporting the findings via a multi-media presentation.

Some embodiments of the disclosed subject matter include a system for performing market research. In some embodiments, the system includes the following: an information collection module for collecting raw information related to a consumer's use of a product or a service, analyzing the raw information, re-exposing the consumer to the analyzed raw information, and interviewing the consumer regarding re-exposure to the product or service to collect additional information; an information analysis module including coding the raw information according to a predefined dictionary of terms thereby generating research data, analyzing the raw information and the additional information using at least one of original, non-traditional, neural network pattern analysis, existing multivariate, and advanced analytical methods to produce findings; and an information reporting module including providing an interactive multimedia presentation of the findings.

### BRIEF DESCRIPTION OF THE DRAWINGS

For the purpose of illustrating the disclosed subject matter, the drawings show a form of the disclosure that is presently preferred. However, it should be understood that the disclosed subject matter is not limited to the precise arrangements and instrumentalities shown in the drawings, wherein:

FIG. 1 is a diagram of a method of performing market research according to some embodiments of the disclosed subject matter; and

FIG. 2 is a schematic representation of a system for performing market research according to some embodiments of the disclosed subject matter.

### DETAILED DESCRIPTION

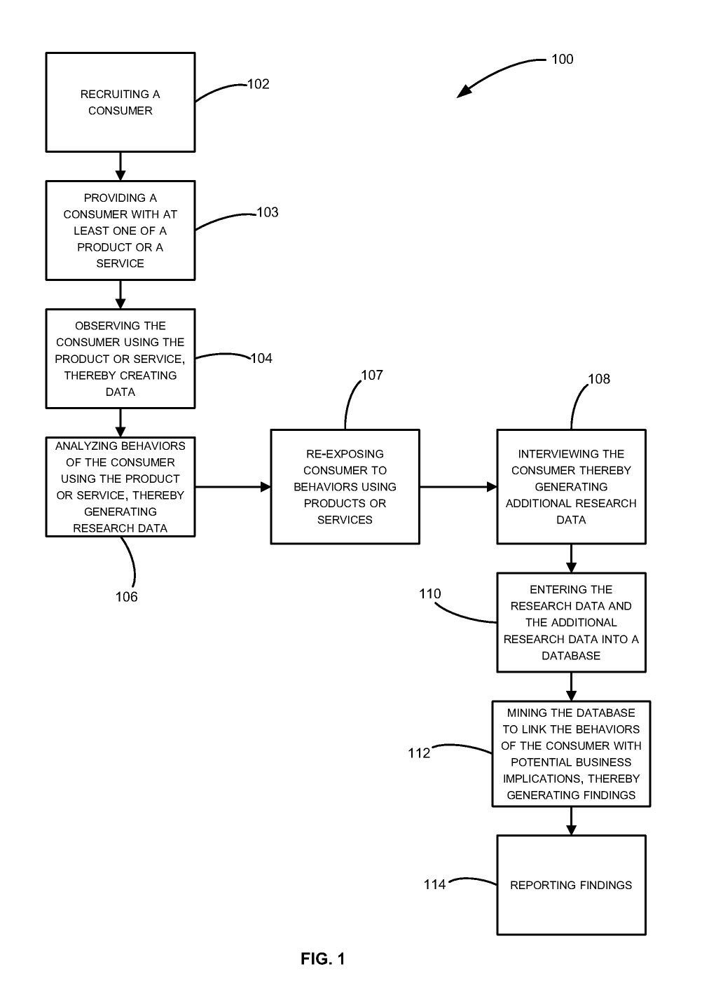

Referring now to the drawings in which like reference numerals indicate like parts, and in particular, to FIG. 1, some embodiments of the disclosed subject matter include a method 100 of performing market research or uncovering marketing findings.

At 102, a participant such as a consumer is recruited to participate in a study of a particular situation, e.g., a business situation such as sampling a product or a service, an academic study, etc. The consumer can be a business or an individual. At 103, the consumer is provided or interacts with at least one of a product or service for purposes of the study. The product can already exist in the consumer's domain or be a new product given to the consumer for purposes of the study. Similarly, the service can be a situation that is already in existence, such as a morning routine, or can be a new situation that the consumer is exposed to for purposes of the study.

At 104, the consumer is observed using the product or service, thereby creating data. The consumer is generally observed using observational techniques including at least one of filming, personal observing, taking pictures, making written or oral diary entries, questioning, and any combination thereof. The observational techniques are typically, but not always, undertaken by the consumer.

As mentioned, in some embodiments, the consumer is filmed by another or by himself or herself while using the product or service thereby creating data in the form of a documentary film. The consumer is instructed to use the product or service in a manner that they would under normal circumstances. Typically, a time frame is given for the length of the study, which can last for days, weeks or months. As the consumer uses the product or service, they are filmed. There can be different levels of filming a consumer. In some embodiments, a consumer can be filmed on a public street using the product being tested. In some embodiments, an in-home monitoring system can be set up in the consumer's home, or the consumer can wear a camera. A daily video feed can then be created. Once the documentary film is created, it is typically stored in a database.

Again, in addition to filming, the consumer can keep a diary or can be observed to collect data. In some embodiments, a diary can be kept online. For example, a consumer selected for the study is granted access to an online community of other consumers participating in the study. The community can be specifically selected to represent key targets of the product or service. The consumer logs onto the community and can make entries on a daily basis. The online community can also be used for follow up questions. The use of an online, written or oral diary is an unobtrusive, effective way to collect a longer period of product or service usage.

In some embodiments, the consumer can be observed by a team of observers in a situation where cameras are not permitted. In some embodiments, the consumer can film themselves using the product or service. The observation methods can be used alone or in combination, depending on the specific circumstances. Factors such as location, size, and length of each study are considered when determining the most effective way to capture the data.

Referring still to FIG. 1, at 106, the behaviors of the consumer are analyzed by reviewing the data, e.g., reviewing a documentary film and or other data gathered while observing the consumer. An analyst such as an anthropologist, or team of anthropologists, can be assigned to a specific person or household to review the documentary film, diary, and observations and mark relevant behaviors. The data can be coded in categories relating to behavior, sociological, psychological, anthropological, and marketing context. The coding of the behavior can be done by using a predefined dictionary of terms created. The dictionary can be created at the outset of the study and be tailored to each specific study. Generally, the coding can consist of a number of descriptive words or phrases, or answers to questions such as “Who?”, “What?”, “Where?” and “When?” The question “Why?” can be categorized or coded based on anthropological, sociological, and psychological descriptors. The observations made are effectively translated into measurable variables by using a coding dictionary, or the like, that can be further analyzed and stored as research data. The research data gathered from the analysis performed at 106 is typically stored in a database.

At 107, in some embodiments, the consumer is re-introduced or re-connected with their behaviors using various methods of speaking with the consumer on an on-going basis until the end of the study. This is typically done prior to future survey work with the consumer. At 108, the consumer is interviewed regarding their use of the product thereby generating additional research data. At 110, the research data gathered at 106 and the additional research data generated at 108 is stored in a database. By re-introducing the consumer with their behaviors and interviewing the consumer using qualitative and quantitative techniques, their actions can be further examined and understood.

At 112, the data included in the database is mined and analyzed to link the behaviors of the consumer with potential business implications using various proprietary and non-proprietary statistical and pattern analyses. From 112, findings are generated. The findings can include, but are not limited to, the potential business implications uncovered and an explanation of the consumers' behaviors. At 114, the findings are reported. The findings are typically, but not always, reported via an interactive multi-media presentation. The multi-media presentation can be displayed in a storybook style, which specifically illustrates how latent or unconscious consumer needs link to corporate business objectives and goals.

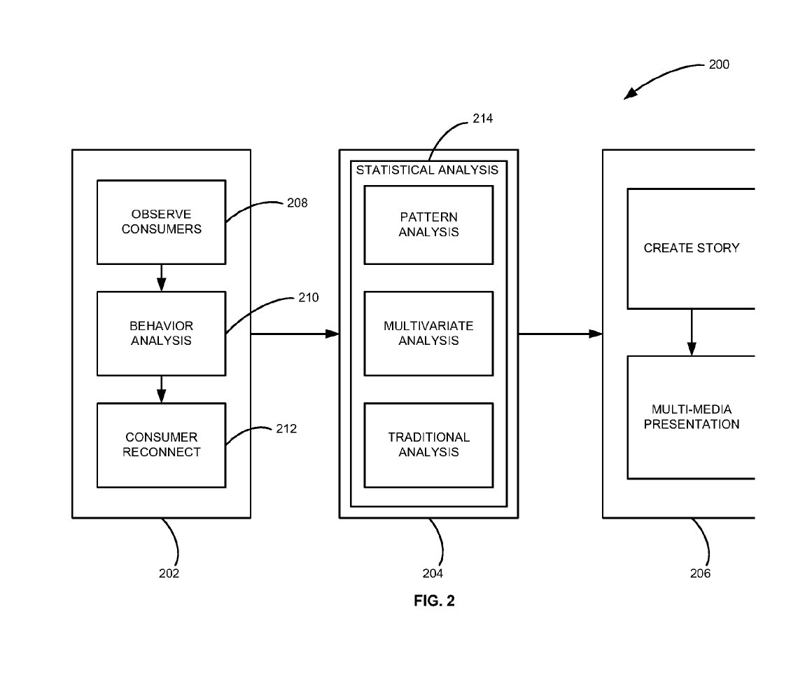

Referring now to FIG. 2, some embodiments of the disclosed subject matter include a system 200 for performing market research. System 200 has a plurality of interconnected modules including an information collection module 202, an information analysis module 204, and an information reporting module 206. Modules 202, 204, and 206 interact to collect, analyze, and report data related to marketing and market research.

Information collection module 202 includes an observation sub-module 208 for collecting raw information related to a consumer's use of a product or a service, an analysis sub-module 210 for analyzing the raw information, and a reconnection sub-module 212 for re-exposing the consumer to the analyzed raw information and interviewing the consumer regarding the re-exposure.

Observation sub-module 208 includes the use of unobtrusive observational techniques such as videos, films, documentaries, pictures, written and oral diaries, observations from trained observers, and a combination thereof to collect raw information related to a consumer's interactions within a situation, or business question, which may include use of a product or a service. Consumers are observed and may be filmed or film themselves using and or receiving products and or services. The location and shots filmed are strategically selected for study objectives and documentary videos are produced.

Analysis sub-module 210 generally includes processes for conducting behavioral analyses of the raw information collected to identify who, what, when, where, and how with respect to the consumer's interactions within a given situation. These behaviors are typically coded using a predefined dictionary of terms. Video clips and research data are typically produced in sub-module 210.

Reconnection sub-module 212 generally includes processes for re-exposing the consumer to the analyzed raw information and interviewing the consumer regarding re-exposure to their behaviors, which may include use of a particular product and or service. Sub-module 212 generally includes methods and process for determining reasons for consumer behaviors and whether they were known or unknown. Tools such as one-on-one interviews, written diaries, and surveys may be used to collect additional information in sub-module 212.

All of the data collected in information collection module 202 is analyzed in information analysis module 204. A comprehensive statistical analysis 214, which includes the use of advanced analytics methods such as neural network pattern analysis, multivariate analyses, and traditional statistical analyses, is typically performed. Results of these analyses are stored in a database. Findings in the form of robust visual, verbal, and numeric information are typically produced in information analysis module 204.

Information reporting module 206 generally includes processes for producing a story 216 linking a company's objectives to consumer needs. Story 216, which includes the findings developed in information analysis module 204, are typically presented in an interactive multimedia presentation 218, which is produced using processes contained within the information analysis module 206.

Another aspect of the disclosed subject matter is a collection of internal tools that are used in the above methods and systems. A first tool is an interactive referral based community leveraged for research studies. The referral-based community is a community of people that help companies innovate new products and services. For example, the referral-based community can begin with contacting friends and family and other participants and encourage referrals and word of mouth about a research study. Next, a website can be dedicated to the study with tools for ongoing communication and information sharing between the consumers. The consumers can consent to video, photo, online and offline information collection techniques for purposes of the study. Certain securities can be put in place to ensure the accuracy of the study, such as an exclusivity agreement; time restrictions, such that consumers can not participate in focus groups or other research studies for a specific amount of time; options to leave the study at a certain point; and screening processes to ensure the right group is targeted.

Another tool that can be used by the person or team analyzing the collected data is a web application. The web application can allow the person or team to view documentary films, build, and review data stored in the database, and stream final presentations. The web application typically includes a secure server that is only accessible with a login and password. Companies and the person or team generally have constant access to the web application.

The person or team analyzing the data can use an application tool to perform the statistical analyses of the data collected. The application may include pattern analysis that leverage neural networks, multivariate analyses, traditional analyses, and other original techniques to uncover findings that improve marketing intelligence. Creative analytic approaches are generally not limited by internal or external development.

A presentation tool can be used to present multimedia presentations that link corporate and consumer needs through an insight driven story. The presentation is used to connect business objectives with consumer opportunity. Visual, verbal, and numeric information is carefully weaved to address business objectives. The presentation tool can provide an advertising quality presentation to client companies.

The disclosed subject matter offers advantages over known methods and systems. Embodiments of the disclosed subject matter offer a new approach that fully captures, understands, and quantifies unarticulated consumer needs, behaviors, and thoughts. Embodiments of the disclosed subject matter provide creative business problem solutions that employ innovative techniques, media, analytics, and technology that result in business knowledge that leads to actionable behavior-based consumer relevant ideas to drive long-term business growth through existing or new brands.

Embodiments of the disclosed subject matter allow marketers to capture actual behaviors and thoughts other methods miss, including the context in which behaviors occur, i.e., surrounding environment, which may have significant influence on behaviors and thoughts. Embodiments of the disclosed subject also allow for the statistical analysis of unstructured and un-standardized data using tools previously not used in marketing. The marketing results of embodiments of the disclosed subject are packaged in a multi-media format that facilitates management's understanding of the results, increases the certainty that decisions are being made with more complete and accurate information, and creates competitive advantages for businesses.

As a result of these mainstream techniques, widespread standardization, and limited value-added research and development in creating marketing intelligence the market research industry have been going through mass consolidation on the supplier or vendor side. In addition, market research teams at corporations or businesses have endured massive cutbacks in staffing and budgets. Embodiments of the disclosed subject matter help to correct existing marketing challenges in the market research industry and business that have led to a lack of ownable business knowledge, increased new product failures, among others.

Another advantage of the disclosed subject matter is incorporating the reality and complexity of today's consumers with progressive means of gathering, interpreting, and reporting ground breaking consumer insight for corporate growth. The disclosed subject matter provides for the ability to quantify unarticulated consumer attitudes, behaviors, and environment not collected through the traditional interview techniques, which are currently leveraged by almost all research companies.

Embodiments of the disclosed subject matter include application of progressive analytic techniques, including neural networks, to uncover patterns in disjointed or “free-form” unstandardized and unstructured information not possible by traditional multivariate techniques. These patterns that are extracted from observational data invariably point to the most fruitful opportunities to drive growth.

Although the invention has been described and illustrated with respect to exemplary embodiments thereof, it should be understood by those skilled in the art that the foregoing and various other changes, omissions and additions may be made therein and thereto, without parting from the spirit and scope of the present invention. Accordingly, other embodiments are within the scope of the following claims.

What is claimed is:

1. A method of performing marketing and market research, said method comprising:
observing a consumer using at least one of a product and a service, thereby creating data;
analyzing behaviors of said consumer using said product or service by reviewing and coding said data, according to a predefined dictionary of terms thereby generating research data;
interviewing said consumer thereby generating additional research data;
entering said research data and said additional research data into a database;
mining and analyzing said database to link said behaviors of said consumer with potential business implications, thereby generating findings; and
reporting findings.

2. A method according to claim 1, further comprising:
re-exposing said consumer to said behaviors using said product or service after analyzing said behaviors of said consumer but before interviewing said consumer.

3. A method according to claim 1, wherein analyzing behaviors of said consumer includes coding said data according to a predefined dictionary of terms.

4. A method according to claim 1, wherein said consumer is observed using observational techniques including at least one of filming, personal observing, taking pictures, making diary entries, questioning, and any combination thereof.

5. A method according to claim 1, wherein said data is a documentary film.

6. A method according to claim 1, wherein said consumer is a business.

7. A method according to claim 1, wherein said findings are reported using an interactive multi-media presentation.

8. A method according to claim 1, further comprising:
recruiting a consumer.

9. A method of performing market research, comprising:
filming said consumer using at least one of a product and a service thereby creating a documentary film;
analyzing behaviors of said consumer using said product or service by reviewing said documentary film;
coding said documentary film according to a predefined dictionary of terms thereby generating research data;
interviewing said consumer regarding said behaviors using said product or service thereby generating additional research data;
entering said research data and said additional research data into a database;
mining and analyzing said database to link said behaviors of said consumer with potential business implications thereby generating findings; and
reporting said findings via a multi-media presentation.

10. A method according to claim 9, wherein said consumer is a business.

11. A method according to claim 9, further comprising re-exposing said consumer to said behaviors using said product or service after analyzing said behaviors of said consumer but before interviewing said consumer.

12. A method according to claim 9, wherein said documentary film is coded for anthropological content.

13. A method according to claim 9, wherein said consumer films himself or herself using said product or service.

14. A system for performing market research, said system comprising:
an information collection module for collecting raw information related to a consumer's use of a product or a service, analyzing said raw information, re-exposing said consumer to said analyzed raw information, and interviewing said consumer regarding re-exposure to the product or service to collect additional information;
an information analysis module including coding said raw information according to a predefined dictionary of terms thereby generating research data, analyzing said raw information and said additional information using at least one of original, non-traditional, neural network pattern analysis, existing multivariate, and advanced analytical methods to produce findings; and
an information reporting module including providing an interactive multimedia presentation of said findings.

15. A system according to claim 14, wherein said information collection module further comprises an observation sub-module wherein said raw information is gathered using observation techniques.

16. A system according to claim 14, wherein said observational techniques include at least one of films, documentaries, pictures, diaries, and a combination thereof.

17. A system according to claim 14, wherein said information collection module further comprises an analysis sub-module wherein behavioral analysis of said raw information is collected.

18. A system according to claim 14, wherein said information collection module further comprises a reconnection sub-module wherein said consumer is re-exposed to said product or service.

19. A system according to claim 14, wherein said consumer is an individual.

20. A system according to claim 14, wherein said consumer is a business.
